(19) United States
(12) Patent Application Publication
(10) Pub. No.: US 2002/0087400 A1
(43) Pub. Date: Jul. 4, 2002

(54) Method and system for providing a reward for playing content received over a data network

(76) Inventors: Denis Khoo, Arcadia, CA (US); Raymond F. Ratcliff III, Plano, TX (US)

Correspondence Address: PILLSBURY WINTHROP, LLP, P.O. BOX 10500, MCLEAN, VA, 22102, US

(21) Appl. No.: 09/750,530

(22) Filed: Dec. 28, 2000

(51) Int. Cl. G06F 17/60

(52) U.S. Cl. 705/14

(57) ABSTRACT

A method and system for providing a reward for displaying motion picture and audio content over a data network. Content is sent over the data network to a content display or playback device. Information identifying a viewer or listener of the content is preferably stored within the device. The content is played back on the display or playback device for a display period. Display verification data is then sent over the data network to a reward engine to verify that the content was played back for the display period. A reward is then provided to the viewer or listener.

### TECHNICAL FIELD

The present invention relates generally to providing content over a data network and, more particularly, to a method and system for providing a reward for playing the content received over the data network.

### BACKGROUND

A reward is often used as an incentive for a customer to perform a certain act. Such rewards are provided by various organizations for simple acts by customers. These acts include purchasing products, completing surveys, attending events, and sampling a product or service offered by a merchant.

One area where incentives have not been used is in the area of advertising. Current advertising models are based on an estimate of the amount of viewers who view or hear the particular advertisements. For example, during a television program, the number of program viewers is estimated, and the advertisements are priced based on that estimate. Unfortunately, a common problem in the advertising industry is that many viewers do not wish to view the advertisement. In the television example, the advertisement is “pushed” on the viewer during a program, and the disinterested viewer often does not wish to watch the advertisement. The viewer has the options of turning off the television during the advertisement, turning the channel, or not watching the advertisement by, for instance, leaving the room.

Television and motion picture broadcasters have been limited in providing incentives to viewers for watching advertisements. This is because the communication is generally one way: the advertisement is received by the television from the broadcaster, with no feedback provided to the broadcaster. The broadcaster does not know which advertisements are actually displayed, much less viewed by the television viewer. Also, the broadcaster is prevented from knowing who is viewing the advertisements. Thus, the lack of two-way communication has limited the broadcaster or the advertiser from providing incentives for those who view the advertisements.

With the advent of the Internet, two-way communication is now available to exchange programming information over data networks. Nonetheless, the viewer of a computer display or television with a set-top box that receives content (e.g. shows, news, sports) still has very little incentive to watch advertisements scattered intermittently throughout non-advertising content. As such, viewers continue the pattern of changing the channel or turning off the television to avoid the pushed advertisement.

Incentives have been provided for performing different activities using the two-way communication model. For example, some Internet companies provide rewards by offering free Internet provider services to users who allow static advertising messages to be displayed while accessing their web site. The user receives the reward of free Internet service, while the advertiser benefits by having the advertisement displayed to the user. However, these advertisements are generally static digital images, as opposed to motion picture content such as television programs or commercials.

Another scheme for providing rewards over the Internet involves search engines that reward users for performing searches using the search engine. For example, certain Internet search engine portal sites are capable of entering a user into a sweepstakes for performing searches on that search engine site. The user cannot, however, be passive. That is, the user must take the affirmative act of performing a search on the Internet using the search engine to receive the reward of being entered into the sweepstakes. Thus, this type of reward requires much more effort on behalf of the user than other passive activities, such as simply watching or listening to some video or audio content.

While the schemes described above may take advantage of advances such as two-way communication available over the Internet, none enable advertisers or broadcasters to provide incentives for passive users to simply view or listen to motion picture or audio content received over data networks.

### SUMMARY

A method and system for providing a reward for displaying motion picture and audio content over a data network. Content is sent over the data network to a content display or playback device. Information identifying a viewer or listener of the content is preferably stored within the device. The content is played back on the display or playback device for a display period. Display verification data is then sent over the data network to a reward engine to verify that the content was played back for the display period. A reward is then provided to the viewer or listener.

Other features and advantages of the invention will become apparent to one with skill in the art upon examination of the following figures and detailed description. It is intended that all such features and advantages be included within this description.

### BRIEF DESCRIPTION OF THE FIGURES

The invention may be better understood with reference to the following figures. The components in the figures are not necessarily to scale, emphasis instead being placed upon clearly illustrating the principles of the present invention. Moreover, in the figures, like reference numerals designate corresponding parts throughout the several views.

FIG. 1 is a block diagram of a system 100 for providing a reward for playing content over a data network, constructed according to an exemplary embodiment of the present invention;

FIG. 2 is a block diagram of a server part 105 in communication with a data network 115 of system 100, for providing a reward for playing content over a data network, constructed according to an exemplary embodiment of the present invention;

FIG. 3 is a block diagram of a system 300 for providing a reward for displaying motion picture content over a data network, constructed according to another exemplary embodiment of the present invention;

FIG. 4 is a block diagram of a system 400 for providing a reward for playing audio content over a data network, constructed according to yet another exemplary embodiment of the present invention;

FIG. 5 is a flow diagram of a method 500 for providing a reward for playing audio content over a data network, performed in accordance with an exemplary embodiment of the present invention;

FIG. 6 is a flow diagram of a method 600 for providing a reward for displaying motion picture content over a data network, performed in accordance with another exemplary embodiment of the present invention; and

FIG. 7 is a block diagram of a computer system 700 constructed according to an exemplary embodiment of the present invention.

### DETAILED DESCRIPTION

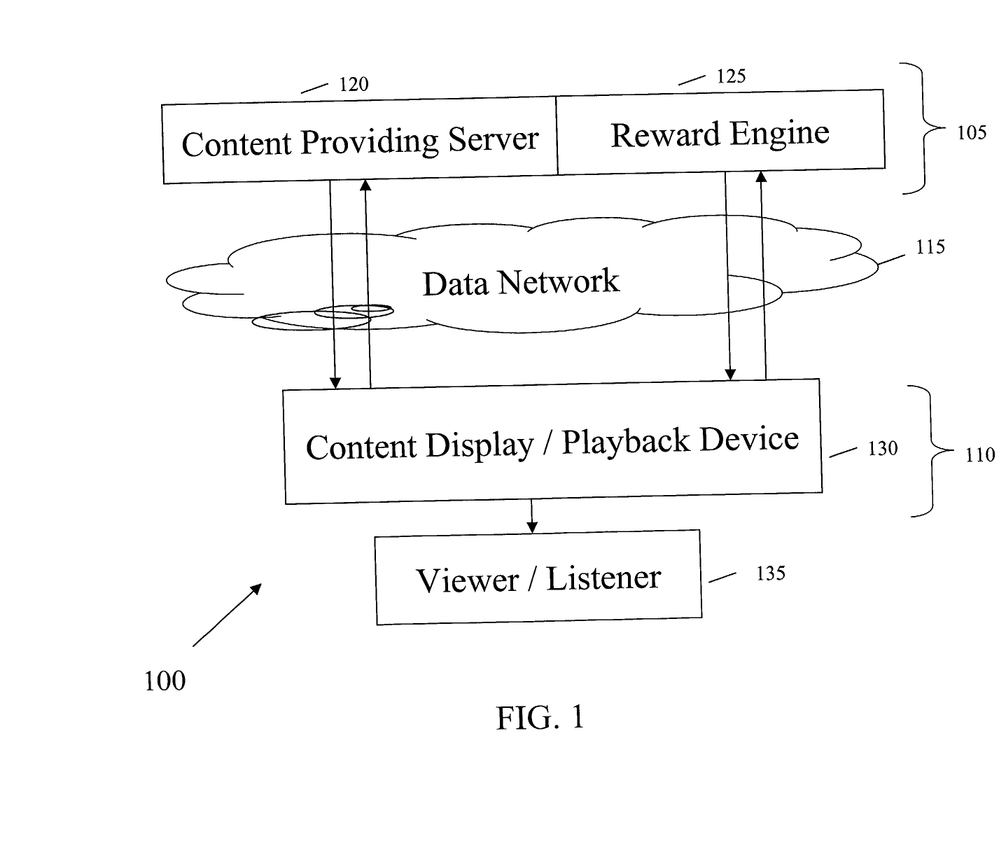

FIG. 1 is a block diagram of a system 100 for providing a reward for playing content over a data network, constructed according to an exemplary embodiment of the present invention. For purposes of describing the features of system 100 and certain other exemplary systems shown in the various figures, the terms “display,” “play,” and “play back” are often used interchangeably, although “display” generally refers to the display of motion picture content, while “play” and “play back” generally refer to the playing of audio content. “Play” and “play back,” however, are also used generically to refer to both the display of motion picture content and/or the playing of audio content. Those skilled in the art will appreciate that many principles of the present invention, including some of those illustrated in FIG. 1, are shared by both video and audio applications.

The term “motion picture content,” as used herein, generally refers to video content which can take various forms. In some exemplary embodiments, the video content includes live action sequences, such as conventional television programs or films in which moving pictures of actual scenes and/or actors have been captured and recorded onto some medium, including both magnetic and digital media. In other exemplary embodiments, the video content includes combinations of live action with animated sequences, such as movies or television programs with special effects. This includes, for example, in-camera special effects such as double exposure, and postproduction special effects such as optical printing and the use of green screens to make composite prints. Postproduction special effects also include stop-motion animation using, for example, clay animation techniques. In other examples, digital special effects such as computer-generated imaging (“CGI”) are added to live action sequences to achieve digital animation. In other examples, animated video content is achieved using cel animation, in which an artist manually paints cels with illustrations. In still other examples, cel animation is combined with post-production techniques to combine live action sequences with animated images. The term “motion picture content” is intended to refer to and include video content generated using all of these techniques.

In FIG. 1, the system 100 includes a server part 105 in communication with a client part 110 via a data network 115. In the exemplary embodiment of FIG. 1, the server part 105 includes a content providing server 120 and a reward engine 125. In exemplary embodiments of system 100, various hardware and/or software configurations are used to realize content providing server 120 and reward engine 125, as will be understood by the skilled artisan. Such hardware generally includes computer devices and/or systems that are capable of receiving and sending data, such as computer system 700 described in greater detail below.

In FIG. 1, data network 115 is any network with sufficient bandwidth to transmit video and audio signals to device 130. Suitable networks include satellite transmission, radio broadcasting, cable television broadcasting, direct line-of-site transmission, telecom fiber optic transmission, cellular transmission, and wireless transmission. Other suitable networks 115 include the Internet, frame relay (FR) networks, ATM networks, wide area networks (WAN), and local area networks (LAN), as will be understood by the skilled artisan.

In FIG. 1, the data network is preferably capable of passing signals between server part 105 and client part 110 in both directions. In some embodiments, however, separate data networks are used for passing such signals; that is, one for passing content signals from server part 105 to client part 110, another for passing information signals from client part 110 to server part 105. The server part 105 and client part 110 are coupled to data network 115 by conventional means, understood by those skilled in the art.

In FIG. 1, an exemplary client part 110 of system 100 includes a content display or playback device 130 which can be monitored by a viewer or listener 135. Examples of a suitable device 130 include a television, computer display, portable phone, cellular phone, and other portable audio devices such as MP3 players. The viewer or listener is desirably situated in proximity to device 130 to view video content displayed on the device 130 and listen to audio content played back on the device. The presence of the viewer or listener when content is played on the device, however, is not essential as will become clear from the description below.

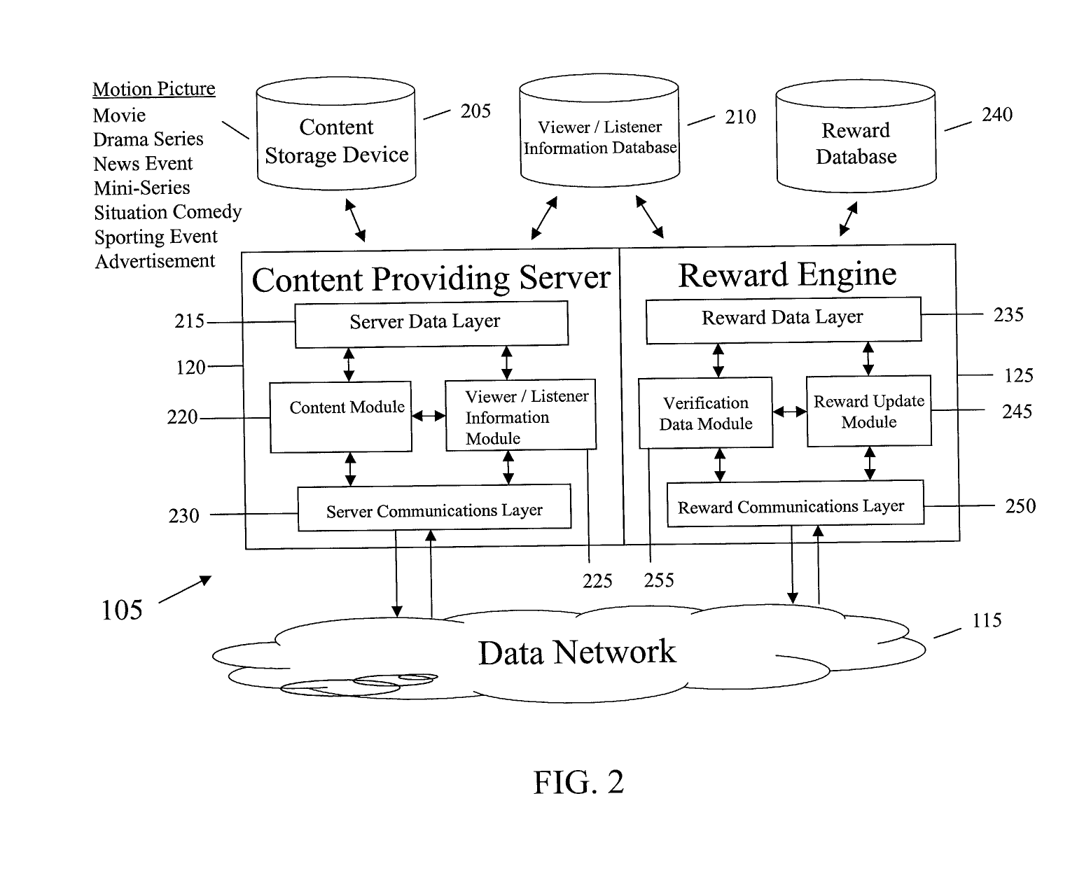

FIG. 2 is a block diagram of server part 105 in communication with data network 115 of system 100, for providing a reward for displaying content over a data network, constructed according to an exemplary embodiment of the present invention. As shown in FIG. 2, content providing server 120 is in communication with a content storage device 205 and an information database 210. The content storage device 205 and database 210 are repositories that include any suitable storage media such as those described below. The storage device 205 and database 210 are coupled to content providing server 120 by conventional means, as will be understood by the skilled artisan.

In FIG. 2, the content storage device 205 is capable of storing video and audio content such as television advertisements, audio advertisements, and other video and audio programs in suitable formats as described herein. In some embodiments, content is recorded on conventional media, such as a magnetic tape. In other embodiments, content is stored in digital form (e.g., digiBeta) on a suitable digital storage medium such as a hard disk, floppy disk, optical disk, magnetic optical disk, digital video disk (“DVD”), compact disk (“CD”), random access memory (“RAM”), EPROM, EEPROM, flash card, smart card, or other removable storage media. In still other embodiments, content is retrieved from other sources such as real time transmission from a data network. Suitable motion pictures stored in content storage device 205 include, for example: drama series, news events, mini-series, movies, sporting events, advertisements, situation comedies, and other suitable programs.

In FIG. 2, the information database 210 serves as a repository containing all of the pertinent data regarding the viewers and listeners served by the system. Information database 210 stores various types of data, including viewing habit information with respect to one or more viewers or listeners. Also, in some embodiments, demographic information related to viewers or listeners is stored in information database 210. In this way, people can be rewarded based on their demographics. For example, an advertisement for a gardening product is shown to viewers who have expressed an interest in gardening, are over 40, and who own a home. Viewers who fit this profile will receive a reward for having the advertisement displayed on their television. In a related example, the rewards are issued only to viewers who not only fit the above profile, but who also play bridge. In this way, the advertiser uses the demographic data to target the reward as well as the advertisement.

In FIG. 2, content providing server 120 includes a server data layer 215 in communication with content storage device 205 and information database 210. The server data layer 215 communicates with content storage device 205 to retrieve content such as motion pictures or audio files from storage device 205 and pass such data to a content module 220. The server data layer 215 also communicates with information database 210 to send and receive information about viewers and listeners to and from the database 210, for purposes described in greater detail below. The content providing server 120 further includes an information module 225 coupled between server data layer 215 and a server communications layer 230. The content module 220 is also in communication with information module 225, both of which are in communication with server communications layer 230. Information is passed between content providing server 120 and data network 115 via server communications layer 230.

In FIG. 2, information module 225 interacts with information database 210 to generate a personalized schedule of programs for particular viewers and listeners served by the system 100. Thus, in some respects, information module 225 provides a logical implementation of the information stored in information database 210. Information module 225 is also in communication with a reward update module 245, described in greater detail below. Personalized information for viewers and listeners who receive awards is passed from information module 225 to reward update module 245 so reward update module 245 can track which viewers and listeners receive rewards. Reward engine 125 can then generate reports identifying the winning viewers and listeners, the rewards they received, and other logistical information such as how the rewards can be delivered to the winners.

In FIG. 2, reward engine 125 includes a reward data layer 235 in communication with a reward database 240. Reward data is passed between reward data layer 235 and reward database 240. The reward data generally includes information describing the reward, the advertiser offering the reward, and the availability of the reward. The reward engine 125 further includes a reward update module 245 coupled between reward data layer 235 and a reward communications layer 250. A verification data module 255 is also coupled between reward data layer 235 and reward communications layer 250. In this way, both verification data module 255 and reward update module 245 both communicate with layers 235 and 250 to pass data between these layers. The reward update module 245 also communicates with verification data module 255. The reward communications layer 250 passes information to and from data network 115.

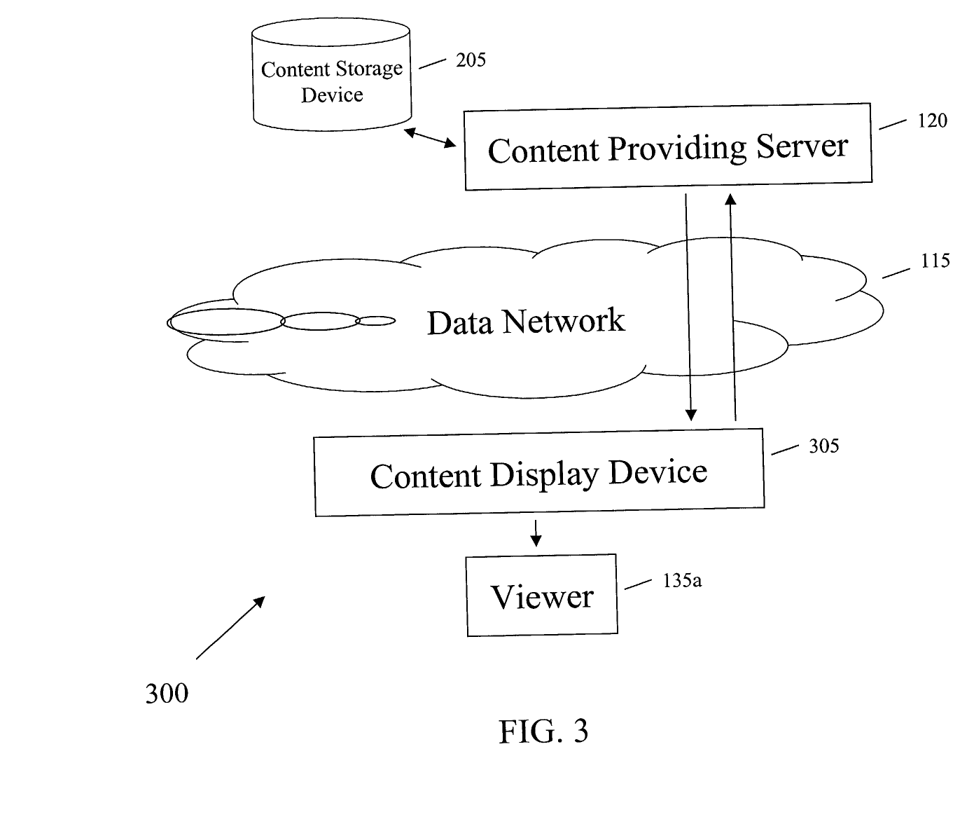

FIG. 3 is a block diagram of a system 300 for providing a reward for displaying content over a data network, constructed according to another exemplary embodiment of the present invention. The system 300 of FIG. 3 is particularly well-suited for the transmission of motion picture content over data network 115. In this embodiment, data network 115 is a cable television network or other suitable data network for sending video, including those described above. The system 300 includes a content display device 305, such as a conventional television, digital television or high-definition television (HDTV), or computer monitor coupled to a computer system. In other examples, content display device 305 includes a personal digital assistant (PDA), a cellular phone with video display, a liquid crystal display (LCD), and other display devices described herein. A viewer 135a can view motion pictures displayed on content display device 305.

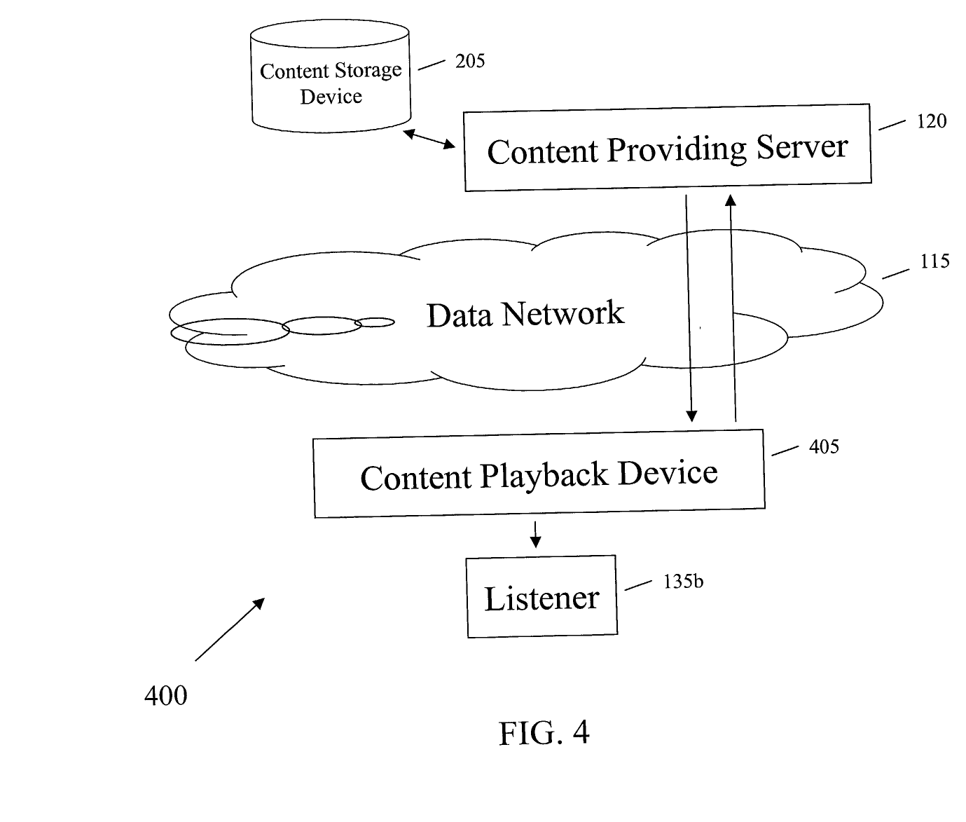

FIG. 4 is a block diagram of a system 400 for providing a reward for playing back content over a data network, constructed according to another exemplary embodiment of the present invention. The system 400 includes a content playback device 405 in communication with data network 115. In this way, content playback device 405 is capable of receiving and playing audio signals provided from content server 120 via data network 115. These signals are played on content playback device 405 for a listener 135b. Various content playback devices 405 can be used, including a radio, television, computer with audio capabilities, a PDA, a cellular telephone, a digital audio player (e.g., MP3 player), and other suitable audio devices.

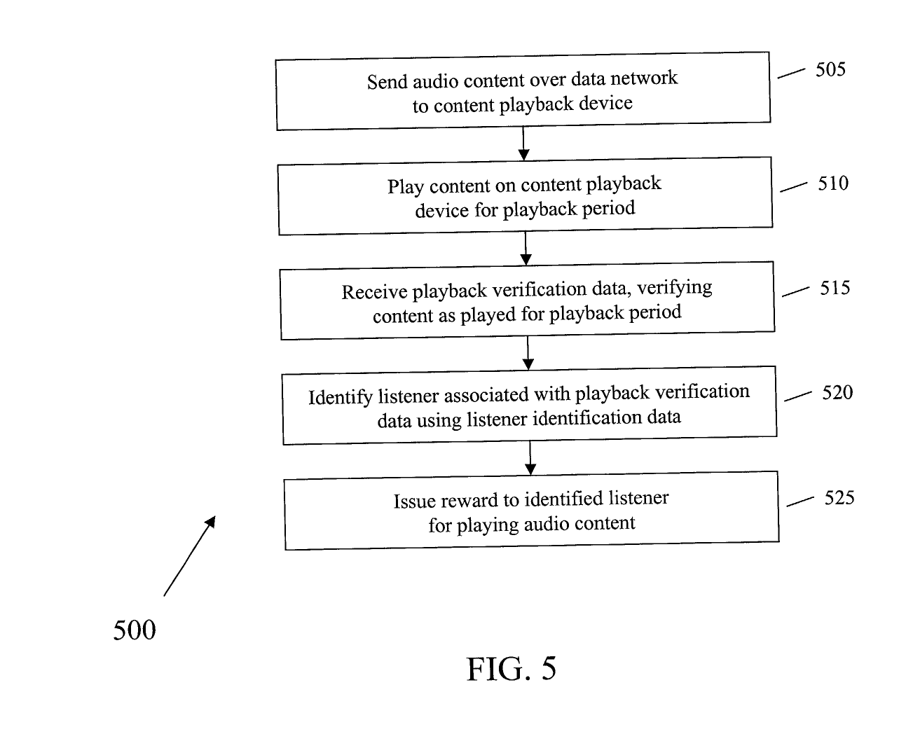

FIG. 5 is a flow diagram of a method 500 for providing a reward for playing audio content over a data network, performed in accordance with an exemplary embodiment of the present invention. FIG. 5 is described generally with reference to the system 400 of FIG. 4, although the principles of method 500 are equally applicable to other exemplary systems of the present invention, as will be appreciated by the skilled artisan. In FIG. 5, after audio content is retrieved by content providing server 120 from content storage device 205, in step 505, the audio content is passed via data network 115 to content playback device 405.

In FIG. 5, after the content is received by content playback device 405, in step 510, the content is played on content playback device 405 for some amount of time, hereinafter referred to as the “playback period.” In other embodiments relating to motion picture content, this period of time is referred to as the “display period.” The playback or display period is generally a predetermined amount of time, monitored by content playback device 405. The playback period associated with the advertisement to be displayed is controlled by content providing server 120. The playback period may be adjusted as desired, depending on the size or length of the content to be displayed. For example, an advertiser may have specific requirements for playback of a commercial. The advertiser may require that the commercial be displayed for at least a certain portion of the total run time for the commercial (e.g., 80 percent of a 30-second commercial, or 25 seconds of display). Thus, in this example, the display period must be greater than or equal to this portion of the run time.

In FIG. 5, after the audio content has been played on content playback device 405 for the playback period, playback verification data is passed from content playback device 405 via data network 115 to the reward engine 125 of FIG. 1. In embodiments related to motion pictures, such verification data is referred to as “display” verification data. In step 515, the reward engine 125 receives the playback verification data. The reward engine 125 interprets the receipt of the playback verification data as verifying that the content was played on content playback device 405 for at least the playback period. In step 520, using listener identification data stored in information database 210 of FIG. 2, reward engine 125 identifies listener 135b of FIG. 4 as associated with the playback verification data received from content playback device 405. This identification process is performed using techniques described in greater detail below. In step 525, a reward is then provided to the listener 135b identified from step 520.

In FIG. 5, the identification process of step 520 is performed using various techniques. In one exemplary embodiment, the information database 210 of FIG. 2 includes data identifying various listeners and viewers served by the system. In one example, a table is maintained. In a first column of the table, a list of listeners and viewers is provided, and in a second column of the table, identification information is maintained in a list of ID entries, each associated with a respective listener or viewer in the first column. Each ID entry in the second column of identification information is unique to the particular viewer or listener with which the ID entry is associated. In one example, the identification information includes serial numbers of content display or playback devices 130 of FIG. 1 used by the viewers and listeners, such as the serial number of a television or other display device. In other examples, the identification information includes IP port addresses, telephone numbers, cable television channel box numbers, login IDs, Global IDs, Onename IDs, Social Security numbers, DL numbers, email addresses, PIN numbers, passwords, and other information. In this way, display verification data passed from the device 130 to reward engine 125 can be identified as associated with a particular viewer. Thus, rewards can be issued to the appropriate viewer or listener. A list of listeners and viewers who have received rewards is maintained using information database 210 of FIG. 2.

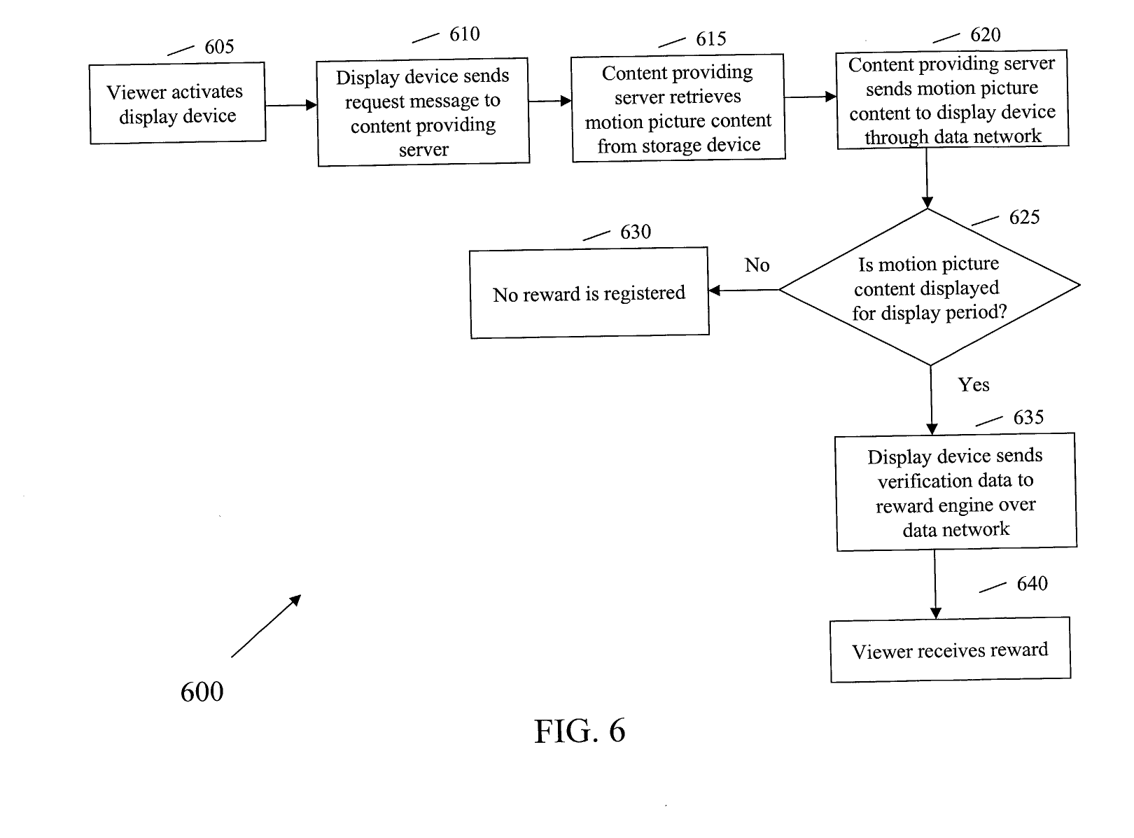

FIG. 6 is a flow diagram of a method 600 for providing a reward for displaying motion picture content over a data network, performed in accordance with an exemplary embodiment of the present invention. As will become clear from the methodology of FIG. 6, if not already apparent from the flow of FIG. 5, entry and participation in the reward process can be active or passive. That is, while it is desirable that the viewer or listener 135 be present when the content is displayed or played back on device 130 of FIG. 1, the viewer or listener need not actually view or listen to the content displayed on the device 130. The device 130 need only be powered and active, such that the content received via data network 115 can be displayed or played back, and verification data can be sent to reward engine 125 via data network 115 when appropriate.

In FIG. 6, the methodology 600 is described with respect to a content display device 305, as shown in FIG. 3, such as a television. The principles illustrated in FIG. 6, however, apply to other display devices and playback devices as will be appreciated by the skilled artisan. FIG. 6 is also described with reference to the system 200 shown in FIG. 2. In step 605, viewer 135a turns on the display device. In step 610, a request message is passed from the content display device 305 via data network 115 to content providing server 120, to request the delivery of motion picture content from content providing server 120. The request message includes ID information identifying the particular viewer associated with content display device 305. Use of the ID information is particularly beneficial in exemplary embodiments where personalized schedules of content are maintained by content providing server 215 for the viewers, so programs and commercials in the personalized schedule can be delivered to the viewer.

In FIG. 2, within content providing server 120, the request message is received by server communications layer 230 from which the message is passed to content module 220. In step 615, through server data layer 215, content module 220 accesses and retrieves motion picture content such as a news event from content storage device 205. The retrieved motion picture content is passed within content providing server 120 to server communications layer 230. In step 620, the motion picture content is sent by server communication layer 230 through data network 115 to content display device 305.

In FIG. 2, a processor within or coupled to content display device 305 monitors whether the motion picture content is displayed for the display period using, for example, an internal software clocking device. The display period is preferably a predetermined amount of time programmed into content display device 305, as explained above. In step 630, if the motion picture content is not displayed at all, or not displayed for at least the display period, no reward is registered for the viewer 135a. Alternatively, in step 635, when the motion picture content is displayed for the display period, verification data is passed from the content display device 305 via data network 115 to reward engine 125. The verification data, including information identifying the viewer or listener associated with display device 305, is received within reward engine 125 by reward communications layer 250 and passed to verification data module 255. This verification data is registered by verification data module 255, confirming that the motion picture content was displayed for at least the display period on the display device 305.

In FIG. 6, the reward update module 245 is activated by verification data module 255 to update reward information stored for the particular viewer 135a associated with content display device 305 within reward database 240. In one exemplary embodiment, within reward database 240, a table identifying viewers and listeners and reward information associated with each is maintained, similar to the table within information database 210. The reward update module 245 communicates with reward database 240 through reward data layer 235 to identify the particular viewer or listener associated with display device 305, using the viewer or listener identification information. This identification information can also be cross-referenced to the information database 210 to retrieve additional information about winning viewers and listeners. In step 640, a reward is then registered for the identified viewer or listener.

Various rewards may be issued in accordance with exemplary embodiments of the present invention, as will be understood by the skilled artisan. In some exemplary embodiments, each reward is unique, and the granting (and availability) of such rewards is maintained in reward database 240. A counter is provided within reward database 240, and a different record is maintained for each reward. Each record contains data including, for instance, a reward description, the advertiser offering the reward, the types of people eligible for the reward, and a list of reward winners. When the identified viewer or listener has already received one or more rewards, the count of rewards for the identified viewer or listener is incremented by one. Thus, in one example, when Person A has seen a particular commercial eighteen times, and Person B has seen the same commercial four times, the reward is issued only to Person A for having seen the commercial more times. Alternatively, a sweepstakes may be conducted in which Person A has eighteen chances to win the prize, while Person B has only four chances.

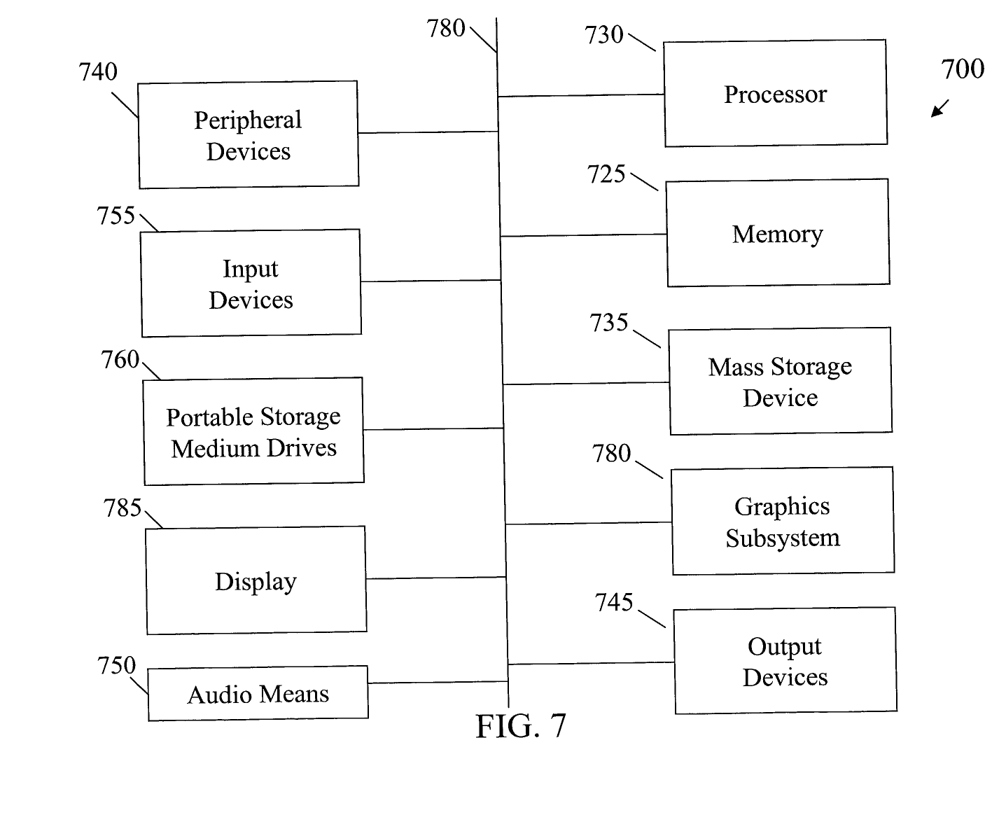

FIG. 7 is a block diagram of a computer system 700 used for performing a method of providing a reward for displaying content over a data network, constructed according to an exemplary embodiment of the present invention. The computer system 700 includes a processor 730 for executing program instructions stored in a memory 725. In some embodiments, processor 730 includes a single microprocessor, while in others, processor 730 includes a plurality of microprocessors to define a multi-processor system. The memory 725 stores instructions and data for execution by processor 730, including instructions and data for performing the methods described above. Depending on the extent of software implementation in computer system 700, the memory 725 stores executable code when in operation. The memory 725 includes, for example, banks of read-only memory (ROM), dynamic random access memory (DRAM) as well as high-speed cache memory.

In FIG. 7, within computer system 700, an operating system comprises program instruction sequences that provide services for accessing, communicating with, and controlling auction server computer system 700. The operating system provides a software platform upon which application programs may execute, in a manner readily understood by those skilled in the art. The computer system 700 further comprises one or more applications having program instruction sequences for providing a reward for displaying content over a data network.

In FIG. 7, the computer system 700 incorporates any combination of additional devices. These include, but are not limited to, a mass storage device 735, one or more peripheral devices 740, an audio means 750, one or more input devices 755, one or more portable storage medium drives 760, a graphics subsystem 780, a display 785, and one or more output devices 745. The various components are connected via an appropriate bus 780 as known by those skilled in the art. In alternative embodiments, the components are connected through other communications media known in the art. In one example, processor 730 and memory 725 are connected via a local microprocessor bus; while mass storage device 735, peripheral devices 740, portable storage medium drives 760, and graphics subsystem 780 are connected via one or more input/output buses.

In FIG. 7, mass storage device 735 is implemented as fixed and/or removable media, for example, as a magnetic, optical, or magneto-optical disk drive. The drive is preferably a non-volatile storage device for storing data and instructions for use by processor 730. In some embodiments, mass storage device 735 stores client and server information, code for carrying out methods in accordance with exemplary embodiments of the invention, and computer instructions for processor 730. In other embodiments, computer instructions for performing methods in accordance with exemplary embodiments of the invention also are stored in processor 730. The computer instructions are programmed in a suitable language such as Java or C++.

In FIG. 7, the portable storage medium drive 760, in some embodiments, operates in conjunction with a portable non-volatile storage medium, such as a floppy disk, CD-ROM, or other computer-readable medium, to input and output data and code to and from the computer system 700. In some embodiments, methods performed in accordance with exemplary embodiments of the invention are implemented using computer instructions that are stored on such a portable medium and input to the computer system 700 via portable storage medium drive 760.

In FIG. 7, the peripheral devices 740 include any type of computer support device, such as an input/output (I/O) interface, to add functionality to computer system 700. In one example, the peripheral devices include a network interface card for interfacing the auction server to a network, a modem, and the like. The peripheral devices also include input devices to provide a portion of a user interface and may include an alphanumeric keypad or a pointing device such as a mouse, a trackball, a stylus, or cursor direction keys. The I/O interface comprises conventional circuitry for controlling input devices and performing particular signal conversions upon I/O data. The I/O interface may include, for example, a keyboard controller, a serial port controller, and/or digital signal processing circuitry.

In FIG. 7, the graphics subsystem 780 and the display 785 provide output alternatives of the system. The graphics subsystem 780 and display 785 include conventional circuitry for operating upon and outputting data to be displayed, where such circuitry preferably includes a graphics processor, a frame buffer, and display driving circuitry. The display 785 may include a cathode ray tube (CRT) display, a liquid crystal display (LCD), or other suitable devices. The display 785 preferably can display at least 256 colors. The graphics subsystem 780 receives textual and graphical information and processes the information for output to the display 785. A video card in the computer system 700 also comprises a part of graphics subsystem 780 and also preferably supports at least 256 colors. For optimal results in viewing digital images, the user should use a video card and monitor that can display the True Color (24 bit color) setting. This setting enables the user to view digital images with photographic image quality.

In FIG. 7, audio means 750 preferably includes a sound card that receives audio signals from a peripheral microphone. In addition, audio means 750 may include a processor for processing sound. The signals can be processed by the processor in audio means 750 of computer system 700 and passed to other devices as, for example, streaming audio signals. In some embodiments, programs for performing methods in accordance with exemplary embodiments of the invention are embodied as computer program products. These generally include a storage medium or media having instructions stored thereon used to program a computer to perform the methods described above. Examples of suitable storage medium or media include any type of disk including floppy disks, optical disks, DVDs, CD ROMs, magnetic optical disks, RAMs, EPROMs, EEPROMs, magnetic or optical cards, hard disk, flash card, smart card, and other media.

Stored on one or more of the computer readable media, the program includes software for controlling both the hardware of a general purpose or specialized computer or microprocessor. This software also enables the computer or microprocessor to interact with a human or other mechanism utilizing the results of exemplary embodiments of the invention. Such software includes, but is not limited to, device drivers, operating systems and user applications. Preferably, such computer readable media further include software for performing the methods described above.

In certain other embodiments, a program for performing an exemplary method of the invention or an aspect thereof is situated on a carrier wave such as an electronic signal transferred over a data network. Suitable networks include the Internet, a frame relay network, an ATM network, a wide area network (WAN), or a local area network (LAN). Those skilled in the art will recognize that merely transferring the program over the network, rather than executing the program on a computer system or other device, does not avoid the scope of the invention.

It should be emphasized that the above-described embodiments of the invention are merely possible examples of implementations set forth for a clear understanding of the principles of the invention. Variations and modifications may be made to the above-described embodiments of the invention without departing from the spirit and principles of the invention. All such modifications and variations are intended to be included herein within the scope of the invention and protected by the following claims.

What is claimed is:

1. A method for providing a reward for displaying a motion picture content over a data network, comprising:
providing the motion picture content;
providing a reward engine;
transmitting the motion picture content over the data network to a content display device, the content display device having information for identifying a viewer of the motion picture content;
displaying, by the content display device, the motion picture content for a display period;
transmitting over the data network, to the reward engine, a display verification data verifying that the motion picture content has been displayed by the content display device for the display period; and
providing the reward to the viewer for displaying the motion picture content.

2. The method of claim 1, wherein the step of providing the motion picture content further comprises:
providing a motion picture advertisement.

3. The method of claim 1, wherein the step of providing the motion picture content further comprises:
providing a movie.

4. The method of claim 1, wherein the step of providing the motion picture content further comprises:
providing a sporting event.

5. The method of claim 1, wherein the step of providing the motion picture content further comprises:
providing a situation comedy.

6. The method of claim 1, wherein the step of providing the motion picture content further comprises:
providing a drama series.

7. The method of claim 1, wherein the step of providing the motion picture content further comprises:
providing a news event.

8. The method of claim 1, wherein the step of providing the motion picture content further comprises:
providing a miniseries.

9. The method of claim 1, wherein the step of transmitting the motion picture content comprises:
providing a content storage device, the content storage device containing the motion picture content;
requesting over the data network, by the content display device, the motion picture content from a content providing server, the content providing server being in communication with the content storage device;
retrieving, from the content storage device, by the content providing server, the motion picture content requested; and
transmitting the motion picture content to the content display device, the motion picture content being transmitted from the content storage device, to the content providing server and then to the content display device through the data network.

10. The method of claim 9, wherein the step of transmitting the motion picture content further comprises:
transmitting the information to the content providing server in the step of requesting the motion picture content from the content providing server; and
storing the information in a viewer information database, the viewer information database being in communication with the content providing server.

11. The method of claim 9, wherein the content display device requests the motion picture content based on a demographic of the viewer.

12. The method of claim 1, wherein the step of displaying the motion picture content further comprises:
displaying the motion picture content on an intelligent television.

13. The method of claim 1, wherein the step of displaying the motion picture content further comprises:
displaying the motion picture content on a computer monitor.

14. The method of claim 1, wherein the step of displaying the motion picture content further comprises:
displaying the motion picture content on a personal digital assistant.

15. The method of claim 1, wherein the step of displaying the motion picture content further comprises:
displaying the motion picture content on a cellular telephone.

16. The method of claim 1, wherein the step of displaying the motion picture content further comprises:
displaying the motion picture content on a liquid crystal display.

17. The method of claim 1, wherein the step of displaying the motion picture content further comprises:
displaying the motion picture content for the display period, the display period being a period of time to display a portion of the motion picture content.

18. The method of claim 1, wherein the step of displaying the motion picture content further comprises:
displaying the motion picture content for the display period, the display period being a period of time to display an entire motion picture content.

19. The method of claim 1, wherein the step of transmitting the display verification data further comprises:
providing the reward engine in communication with the content providing server;
identifying, to the reward engine through the display verification data, the motion picture content being displayed; and
identifying, to the reward engine through the display verification data, the viewer information to identify the content display device displaying the motion picture content.

20. The method of claim 1, wherein the step of providing the reward to the viewer further comprises:
entering the viewer into a sweepstakes.

21. The method of claim 1, wherein the step of providing the reward to the viewer further comprises:
entering the viewer into a sweepstakes, wherein the viewer is entered into the sweepstakes upon each instance that the motion picture content is displayed on the content display device.

22. The method of claim 1, wherein the step of providing the reward to the viewer further comprises:
providing a monetary award to the viewer.

23. The method of claim 1, wherein the step of providing the reward to the viewer further comprises:
providing the viewer a product being displayed in the motion picture content.

24. The method of claim 1, wherein the step of providing the reward to the viewer further comprises:
providing the viewer a service being displayed in the motion picture content.

25. A method for providing a reward for transmitting an audio content over a data network, comprising:
providing the audio content;
providing a reward engine;
transmitting the audio content to a content playback device over the data network, the content playback device having information for identifying a listener of the audio content;
transmitting, by the content playback device, the audio content for a transmission period;
transmitting, to the reward engine over the data network, a transmission verification data verifying that the audio content has been transmitted by the content playback device for the transmission period; and
providing the reward to the listener for transmitting the audio content.

26. The method of claim 25, wherein the step of providing the audio content further comprises:
providing a sound advertisement.

27. The method of claim 25, wherein the step of transmitting the audio content further comprises:
providing a content storage device, the content storage device containing the audio content;
requesting over the data network, by the content playback device, the audio content from a content providing server, the content providing server being in communication with the content playback device;
retrieving, from the content storage device, by the content providing server, the audio content requested; and
transmitting the audio content to the content playback device, the audio content being transmitted from the content storage device, to the content providing server and then to the content playback device.

28. The method of claim 27, wherein the step of transmitting the audio content further comprises:
transmitting the information to the content providing server in the step of requesting the audio content from the content providing server; and
storing the information in a listener information database, the listener information database being in communication with the content providing server.

29. The method of claim 27, wherein the content playback device requests the audio content based on a listening habit of the listener.

30. The method of claim 27, wherein the content playback device requests the audio content based on a demographic of the listener.

31. The method of claim 25, wherein the step of transmitting the audio content further comprises:
transmitting the audio content on a radio.

32. The method of claim 25, wherein the step of transmitting the audio content further comprises:
transmitting the audio content on a television.

33. The method of claim 25, wherein the step of transmitting the audio content further comprises:
transmitting the audio content on a computer speaker.

34. The method of claim 25, wherein the step of transmitting the audio content further comprises:
transmitting the audio content on a personal digital assistant.

35. The method of claim 25, wherein the step of transmitting the audio content further comprises:
transmitting the audio content on a cellular telephone.

36. The method of claim 25, wherein the step of transmitting the audio content further comprises:, transmitting the audio content on a digital audio player.

37. The method of claim 25, wherein the step of transmitting the audio content further comprises:
transmitting the audio content for the transmission period, the transmission period being a period of time to transmit a portion of the audio content.

38. The method of claim 25, wherein the step of transmitting the transmission verification data further comprises:
providing the reward engine in communication with the content providing server;
identifying, to the reward engine through the transmission verification data, the audio content being transmitted; and
identifying, to the reward engine through the transmission verification data, the content playback device transmitting the audio content.

39. The method of claim 25, wherein the step of providing the reward to the listener further comprises:
entering the listener into a sweepstakes.

40. The method of claim 25, wherein the step of providing the reward to the listener further comprises:
entering the listener into a sweepstakes, wherein the listener is entered into the sweepstakes upon each instance that the audio content is transmitted on the content playback device.

41. The method of claim 25, wherein the step of providing the reward to the listener further comprises:
providing a monetary award to the listener.

42. The method of claim 25, wherein the step of providing the reward to the listener further comprises:
providing the listener a product being promoted in the audio content.

43. The method of claim 25, wherein the step of providing the reward to the listener further comprises:
providing the listener a service being promoted the audio content.

44. A system for providing a reward for displaying a motion picture content over a data network, comprising:
a content display device for displaying the motion picture content;
a content providing server, the content providing server having a processor for communicating with the content display device and a content storage device, the content providing server further having a reward engine; and
the content storage device, the content storage device having computer instructions stored thereon, that, when loaded into a computer, cause the computer to perform the method of:
transmitting the motion picture content over the data network to the content display device, the content display device having a viewer information for identifying a viewer of the motion picture content;
displaying, by the content display device, the motion picture content for a display period;
transmitting over the data network, to the reward engine, a display verification data verifying that the motion picture content has been displayed for the display period; and
providing the reward to the viewer for displaying the motion picture content.

45. The system of claim 44, wherein the content display device requests the motion picture content based on a viewing habit of the viewer.

46. The system of claim 44, wherein the content display device requests the motion picture content based on a demographic of the viewer.

47. The system of claim 44, wherein the content display device is a television.

48. The system of claim 44, wherein the content display device is a computer monitor.

49. The system of claim 44, wherein the content display device is a personal digital assistant.

50. The system of claim 44, wherein the content display device is a cellular telephone.

51. The system of claim 44, wherein the content display device is a liquid crystal display.

52. A system for providing a reward for transmitting an audio content over a data network, comprising:
a content playback device for transmitting the audio content;
a content providing server, the content providing server having a processor for communicating with the content playback device and a content storage device, the content providing server further having a reward engine; and
the content storage device, the content storage device having computer instructions stored thereon, that, when loaded into a computer, cause the computer to perform the method of:
transmitting the audio content to the content playback device over the data network, the content playback device having information for identifying a listener of the audio content;
transmitting, by the content playback device, the audio content for a transmission period;
transmitting, to the reward engine over the data network, a transmission verification data verifying that the audio content has been transmitted by the content playback device for the transmission period; and providing the reward to the listener for transmitting the audio content.

53. The system of claim 52, wherein the audio content is a sound advertisement.

54. The system of claim 52, wherein the audio content is a sporting event.

55. The system of claim 52, wherein the audio content is a situation comedy.

56. The system of claim 52, wherein the audio content is a drama series.

57. The system of claim 52, wherein the audio content is a news event.

58. The system of claim 52, wherein the audio content is a miniseries.

59. A computer readable medium having computer instructions stored thereon that, when loaded into a computer system, cause the computer system to perform the method for providing a reward for displaying a motion picture content over a data network, the method comprising:
providing the motion picture content;
providing a reward engine;
transmitting the motion picture content over the data network to a content display device, the content display device having information for identifying a viewer of the motion picture content;
displaying, by the content display device, the motion picture content for a display period;
transmitting over the data network, to the reward engine, a display verification data verifying that the motion picture content has been displayed by the content display device for the display period; and
providing the reward to the viewer for displaying the motion picture content.

60. A computer readable medium having computer instructions stored thereon that, when loaded into a computer system, cause the computer system to perform the method for providing a reward for transmitting an audio content over a data network, comprising:
providing the audio content;
providing a reward engine;
transmitting the audio content to a content playback device over the data network, the content playback device having information for identifying a listener of the audio content;
transmitting, by the content playback device, the audio content for a transmission period;
transmitting, to the reward engine over the data network, a transmission verification data verifying that the audio content has been transmitted by the content playback device for the transmission period; and
providing the reward to the listener for transmitting the audio content.

61. An electronic signal, comprising:
computer instructions that, when loaded into a computer, cause the computer to perform a method for providing a reward for displaying a motion picture content over a data network, the method comprising:
providing the motion picture content;
providing a reward engine;
transmitting the motion picture content over the data network to a content display device, the content display device having information for identifying a viewer of the motion picture content;
displaying, by the content display device, the motion picture content for a display period;
transmitting over the data network, to the reward engine, a display verification data verifying that the motion picture content has been displayed by the content display device for the display period; and
providing the reward to the viewer for displaying the motion picture content.

62. An electronic signal, comprising:
computer instructions that, when loaded into a computer, cause the computer to perform a method for providing a reward for transmitting an audio content over a data network, comprising:
providing the audio content;
providing a reward engine;
transmitting the audio content to a content playback device over the data network, the content playback device having information for identifying a listener of the audio content;
transmitting, by the content playback device, the audio content for a transmission period;
transmitting, to the reward engine over the data network, a transmission verification data verifying that the audio content has been transmitted by the content playback device for the transmission period; and
providing the reward to the listener for transmitting the audio content.
